(19) United States
(12) Patent Application Publication
(10) Pub. No.: US 2006/0265260 A1
(43) Pub. Date: Nov. 23, 2006

(54) System and method for browsing and comparing products

(76) Inventors: Robert Brown, Newport Beach, CA (US); Craig Perkins, San Clemente, CA (US); Kevin Perkins, San Clemente, CA (US); Doug Bregman, San Clemente, CA (US); George A. Lopez, Laguna Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/418,484

(22) Filed: May 3, 2006

Related U.S. Application Data
(63) Continuation of application No. 09/213,138, filed on Dec. 16, 1998.

(51) Int. Cl. G06F 9/44; G06F 7/00; G06F 17/50; G06F 17/00

(52) U.S. Cl. 705/7; 707/100

(57) ABSTRACT

A system and method permit a user to browse and compare products of a merchant using information about a competitor. In one embodiment of the system and method, a page server serves a competitor electronic page to a customer browser which permits the user to select a competitor. The competitor electronic page includes a hyperlink having a manufacturer ID parameter, which hyperlink, when selected, issues a request to the page server for competitor product information. The request includes the manufacturer ID. Responsive to that request, the page server uses the manufacturer ID to form a query to present to a product database having competitive product information, manufacturer information, product information and associations between that information. A database engine processes the query and returns records satisfying the query. The records are used to construct a competitor product electronic page permitting a user to select a competitor product. The page server serves the competitor product electronic page to the customer browser. The competitor product electronic page includes hyperlinks corresponding to competitor products, each hyperlink, when selected, issuing a request for corresponding product information, and each hyperlink including a corresponding product ID parameter transmitted with the issued request. The page server responds to a request for corresponding product information by using the corresponding product ID parameter to query the product database for corresponding product information. The records satisfying the query are returned and used to construct an electronic page including corresponding product information. The page server sends the electronic page including the corresponding product information to the customer browser.

### CROSS-REFERENCE TO RELATED APPLICATION

This application is a continuation of U.S. application Ser. No. 09/213,138, filed Dec. 16, 1998, which is incorporated by reference in its entirety

### BACKGROUND OF THE INVENTION

1. Field of the Invention

The invention relates to electronic commerce. More particularly, the invention provides a system and method which permit customers to browse and compare products using information about competitors' products.

2. Description of the Related Art

Merchants now use the Internet to advertise and sell products of all types, from software titles and audio CD's to cars, trucks and boats. Permitting dramatic cost reductions in both expensive store square footage and burdened labor, this trend will only increase.

Electronic commerce systems now exist which merchants can purchase, install and use to advertise and sell their goods over the Internet and the World Wide Web. These systems generally combine a configurable product database, a Web page production tool, a Web server and a payment processing module.

Using such an electronic commerce system, a merchant populates the product database with product description information and pricing. The merchant also designs a series of Web pages to convey the product information to customers using Web browsers such as Netscape's Communicator or Microsoft's Internet Explorer. The Web pages are hosted by the Web server, which downloads Web page information to a requesting customer's Web browser.

The merchant organizes the Web pages by placing one or more hyperlinks within each page. Using the hyperlinks, the merchant determines which of his or her other Web pages a customer can access from each Web page. When a customer selects a hyperlink, the customer's Web browser requests access to a different Web page associated with the selected hyperlink. The hyperlinks interlinking the merchant's Web pages thus permit customers to navigate through the Web pages comprising the merchant's electronic store, in particular to browse through the merchant's products.

Such existing electronic commerce systems provide no mechanism, however, for a merchant to effectively cause browsing customers to switch from a competitor's product to purchase its product instead. This is particularly true in cases where a merchant sells a vast array of products, each differing only slightly from the next, such as connectors or fasteners, grommets, filters, cables, tubes and hoses of varying properties, and so on.

One problem for merchants in these and other situations is that the ten or fifteen minutes that might be required for a browsing customer to read through product categories and specifications to locate the right product from a large and unfamiliar product set with no guarantee of success may well be enough to discourage the customer from even attempting to locate a product in the first place. Rather than use an electronic store to find a better deal, such a customer may simply go on using the familiar products of a competitor, using the competitor's arcane but memorized model number to place continuing orders from month-to-month for numerous cases of products.

Merchants need an effective mechanism to allow customers, intimately familiar with a competitor, to quickly browse their electronic stores and make an informed, on-the-spot decision to change suppliers.

### SUMMARY OF THE INVENTION

The present invention provides a system and method permitting customers to browse and compare products of a merchant advantageously using information about a competitor. Thus, for example, by supplying or selecting a model number or other identifier associated with a competitor's product, the system and method of the present invention provide the user with information about a corresponding product of the merchant.

The invention is compatible with electronic stores and may operate over a network, such as the Internet, to permit customers at any location to browse and compare a merchant's products. The invention may further inform a customer regarding differences in price between a competing product and the corresponding merchant product.

One embodiment of the present invention is a system for browsing products using competitor information. The system comprises (1) a product database including first data representing a product, including second data representing a competing product, and including third data representing an association between the product and the competing product, the product database stored on a computer readable medium; (2) a dynamic page file for generating an electronic store page, the dynamic page file including instructions to use the second data as a query parameter to obtain the first data from the product database, the first data included in the electronic store page, the dynamic page file stored on the computer readable medium; and (3) a product information server responsive to a customer request for the electronic store page to access the dynamic page file, to process the instructions and to provide the electronic store page to the customer, the product information server running on a computer operably connected to the computer readable medium. Another aspect of the embodiment is one, wherein the product database includes data representing an association between a manufacturer and the second data, the embodiment further comprising a second dynamic page file for generating a second electronic store page, the dynamic page file including second instructions to use information identifying a manufacturer as a query parameter to obtain the second data from the product database, the second data included in the second electronic store page, the second dynamic page file stored on the computer readable medium. A further aspect of the embodiment is one wherein the product information server responds to a customer request for the second electronic store page by accessing the second dynamic page file, by processing the second instructions, and by providing the second electronic store page to the customer. Another aspect of the system further comprises an electronic store page having a hyperlink responsive to a customer selection of the hyperlink to generate the request. A further aspect of the embodiment further comprises a customer browser which transmits the second data to the page server upon the selection of the hyperlink. Still a further aspect of the embodiment is one wherein the product database includes product cost information related to the product, and this aspect further comprises (1) a cost savings form on the electronic store page, the cost savings form receiving competing cost information about the competing product, the customer browser transmitting the cost information to the page server; and (2) second instructions in the dynamic page file for comparing the competing cost information and the product cost information to calculate cost savings information, the product information server providing the savings information to the customer.

Another embodiment of the present invention is a method for locating information about a product using information about a corresponding product. The embodiment comprises the steps of: (1) transmitting with a page server at least one corresponding product hyperlink to a customer browser, the at least one corresponding product hyperlink operatively associated with a corresponding product identifier representing a corresponding product and operatively associated with a page file identifier representing a corresponding product page file; (2) receiving with the customer browser the corresponding product hyperlink; (3) displaying with the customer browser information identifying a product, a portion of the displayed information selectable to activate the corresponding product hyperlink; and (4) responding to a selection of the portion by transmitting to the page server a request for the corresponding product page file and by transmitting to the page server the product identifier. One aspect of the embodiment comprises the further steps of: (5) receiving with the page server the request for the corresponding product page file and the identifier; (6) processing instructions in the page file to use the identifier to obtain data representing a corresponding product; and (7) transmitting with the page server to a customer browser the data representing the corresponding product. A further aspect of the embodiment comprises the further steps of: (8) transmitting with the page server at least one manufacturer hyperlink to a customer browser, the at least one manufacturer hyperlink operatively associated with a manufacturer identifier representing a manufacturer and operatively associated with a second page file identifier representing a manufacturer product list page file; (9) receiving with the customer browser the manufacturer hyperlink; (10) displaying with the customer browser second information identifying the manufacturer, a portion of the displayed second information selectable to activate the manufacturer hyperlink; and (11) responding to a selection of the portion of the second information by transmitting to the page server a request for the manufacturer product list page file and by transmitting to the page server the manufacturer identifier. A still further aspect of the embodiment comprises the further steps of: (12) receiving with the page server the request for the manufacturer product list page file and the manufacturer identifier; (13) processing second instructions in the manufacturer product list page file to use the manufacturer identifier to obtain data representing products of the manufacturer, and (14) transmitting with the page server to a customer browser the data representing the products of the manufacturer.

A still further embodiment of the present invention is an e-store dynamic page file. The embodiment comprises: (1) static content including content identification tags which may be interpreted to format the content; and (2) script components including: (a) connection instructions to establish a connection to a product database; (b) query instructions to query the product database using a search key provided to the query instructions as a parameter, and to thereby obtain a recordset including at least one record, each of the at least one records including information about competing products; and (c) hyperlink creation instructions to create a hyperlink for each of the at least one records, each hyperlink referencing a corresponding product page file for transmitting information about a corresponding product, each hyperlink including an identifier representing a corresponding product. One aspect of the embodiment further comprises: (3) a cost savings form including at least one text entry field for accepting competing cost information related to the cost of the competing products and including a cost savings hyperlink, the cost savings hyperlink referencing a corresponding product page file for transmitting information about a difference in cost between the products and the competing products, the cost savings hyperlink including an identifier representing a corresponding product and at least one cost identifier representing the competing cost information. A further aspect of the embodiment is one wherein the script components further include form placement instructions for generating the cost savings form once for each of the at least one records.

Another embodiment of the invention is a system for locating information about products. The embodiment comprises: (1) associating means for storing an association between a product and a corresponding product; (2) requesting means responsive to an identification of the product to request information about the corresponding product; (3) query means for using the identification of the product to access the associating means and to thereby obtain the information about the corresponding product; (4) information assembly means responsive to the request to invoke the query means and to format the information about the corresponding product; and (5) transmitting means for presenting to a customer the formatted information about the corresponding product.

### BRIEF DESCRIPTION OF THE DRAWINGS

FIG. 1 illustrates a representation of a computer network that may be used in the operation of an embodiment of the present invention;

FIG. 2 illustrates a representation of components of one embodiment of the present invention;

FIG. 3 illustrates a representation of steps, in one embodiment of the present invention, to construct the product database;

FIG. 4 illustrates a product database used in one embodiment of the present invention having a products table, a manufacturer table, a competitive products table, and a cross reference table;

FIG. 5 illustrates steps in one embodiment of the present invention to create e-store pages facilitating customer browsing;

FIG. 6 illustrates a representation, in one embodiment of the present invention, of a page file including a competitor comparison hyperlink;

FIG. 7 illustrates a representation, in one embodiment of the present invention, of a competitor comparison dynamic page file;

FIG. 8 illustrates a representation, in one embodiment of the present invention, of a competitor product list dynamic page file;

FIG. 9 illustrates a representation, in one embodiment of the present invention, of a corresponding product dynamic page file; and

FIGS. 10A and 10B comprise a flow diagram representing the operation of an embodiment of the present invention compatible with an Internet-based electronic store.

### DETAILED DESCRIPTION OF THE PREFERRED EMBODIMENT

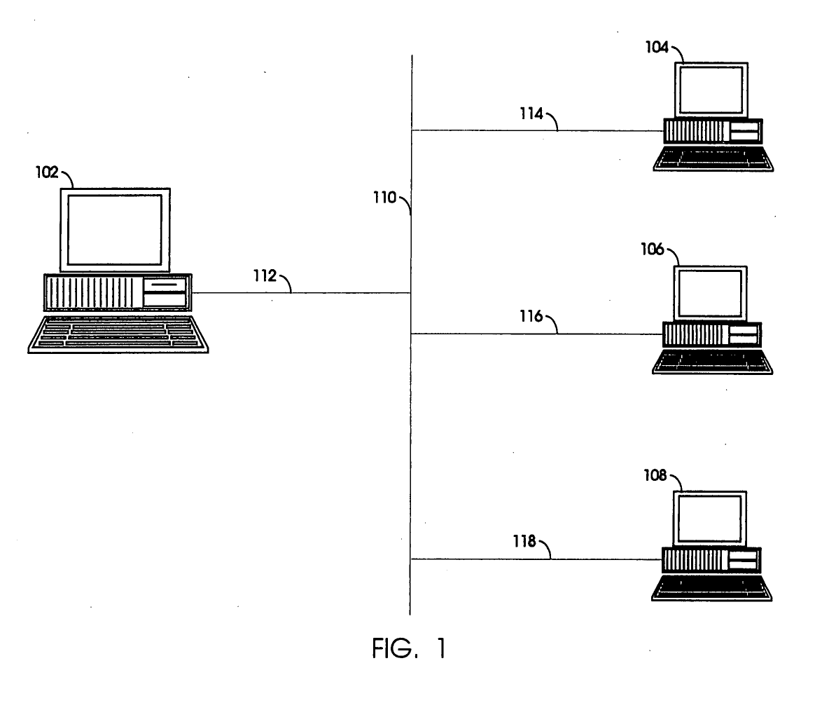

The present invention includes a product browsing system, which operates in many embodiments, but is particularly suited for operating over a network in connection with an electronic shopping (or e-commerce) system. FIG. 1 illustrates a representation of a computer network that may be used in the operation of an embodiment of the present invention. A merchant computer 102 facilitates sales-related transactions between a merchant and customers. The transactions may include advertising products, searching for products, listing the specifications and performance characteristics of products, comparing products, setting up accounts, ordering and shipping products, controlling inventory, maintaining customer lists, performing general ledger accounting, and handling customer service matters such as product returns, warranties, troubleshooting and answering frequently asked questions.

In a preferred embodiment, the invention is used in the field of medical products. More particularly, the invention may be used by a merchant selling medical administration sets or tubing kits. In should be readily noted, however, that the invention may be used in advertising and selling a wide variety of products and services, such use being expressly comtemplated by the inventors hereto.

In a preferred embodiment of the present invention, the merchant computer 102 hosts a browsing system, possibly as part of an electronic store. The browsing system advantageously permits a potential customer to use competitive product information to locate the merchant's own products and to compare their characteristics against those of possibly more familiar products of a competitor.

The merchant computer 102, in one embodiment has an Intel Pentium II processor running at 450 MHz, has 256 MB (megabytes) of RAM (random access memory), and has approximately 6 GB (gigabytes) of hard disk storage. The merchant computer 102 also includes a standard monitor, mouse and keyboard. The merchant computer 102 is connected to a network 110 by a standard T1 connection 112. In this embodiment, the merchant computer 102 runs Microsoft Windows NT Server 4.0 operating system.

In this embodiment of the present invention, customers access the merchant's product data using customer computers 104, 106, 108. A customer computer may be virtually any type of computer capable of accessing a network. In one embodiment, however, a customer computer has the same hardware characteristics as the merchant computer 102, though a computer with less processor, memory, and hard disk capacity would suffice, and the customer computers run the Microsoft Windows 98 operating system.

The customer computers may use a variety of connections to the network 110 to access the merchant's product data. For example, the customer computer 104 is connected to the network 110 using a 28.8 kbps modern connected to a standard telephone line 114. Another customer computer 106 is connected to the network 110 using a fibre optic cable line 116. Still another customer computer 108 is connected to the network 110 using a wireless link 118. The present invention may operate with any type of communication method permitting a customer computer 104, 106, 108 to access a network, including a direct connection such as one whereby a customer computer uses a standard network card to connect to a LAN or WAN.

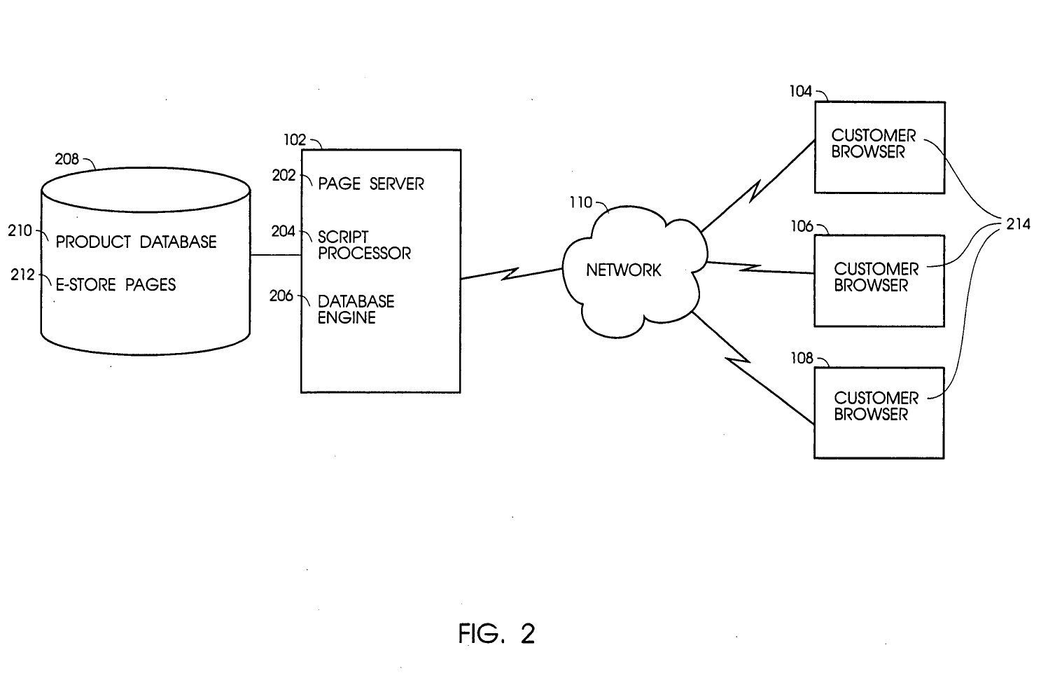

FIG. 2 illustrates a representation of components of one embodiment of the present invention. The merchant computer 102 hosts a page server 202. In one embodiment, the page server is Microsoft Internet Information Server (IIS) which runs as a service under Windows NT. In that embodiment, the pages served by IIS are HTML (hypertext markup language) compliant pages capable of being served to other computers over the Internet. Windows NT provides TCP/IP communication protocol to communicate over the Internet.

A script processor 204 runs on the merchant computer 102. In one embodiment of the present invention, an Active Server Pages (ASP) layer of IIS processes scripts to generate web pages. A database engine 206 also runs on the merchant computer 102. While any one of a large number of available database systems may be used with the present invention, this embodiment uses Microsoft's Access database. The database engine may also be any device, program or module which, upon being provided with search criteria, scans a body of data to locate data satisfying the search criteria.

The merchant computer 102 accesses data stored on a computer readable storage 208, which, in the present embodiment, is a hard disk drive having roughly 6 GB of storage capacity. A product database 210 is stored on the storage 208, as is a collection of electronic store (e-store) pages 212. The page server 202 accesses the c-store pages 212, and the script processor 204 processes scripts in the e-store pages 212. The database engine 206 accesses the product database 210 to add, delete, or update records or to query various database tables of the product database 210.

The merchant computer 102 is connected to the network 110, in one embodiment, the Internet, by the line 112. The customer computers 104, 106, 108—also connected or connectable to the Internet—run customer browser programs 214 to request and receive web pages from the merchant's electronic store. In this embodiment, the browser programs are standard web browsers, such as Netscape Communicator or Microsoft Internet Explorer. In an alternative embodiment, the network 110 may be a LAN (local area network) or WAN (wide area network) supporting an Intranet.

Product Database

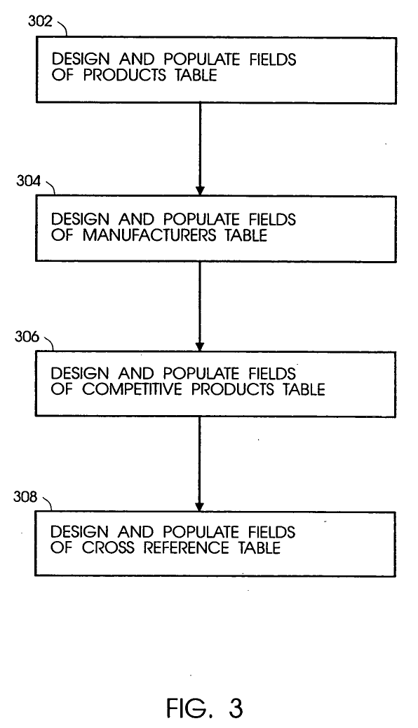

FIG. 3 illustrates a representation of steps, in one embodiment of the present invention, to construct the product database 210. In a first step 302, a merchant, or other person, designs and populates fields of a products table. Those of ordinary skill in the art will appreciate that such design step involves deciding which data items will be aggregated together for each product to be represented in the products table, and determining the type of data field needed to represent each item.

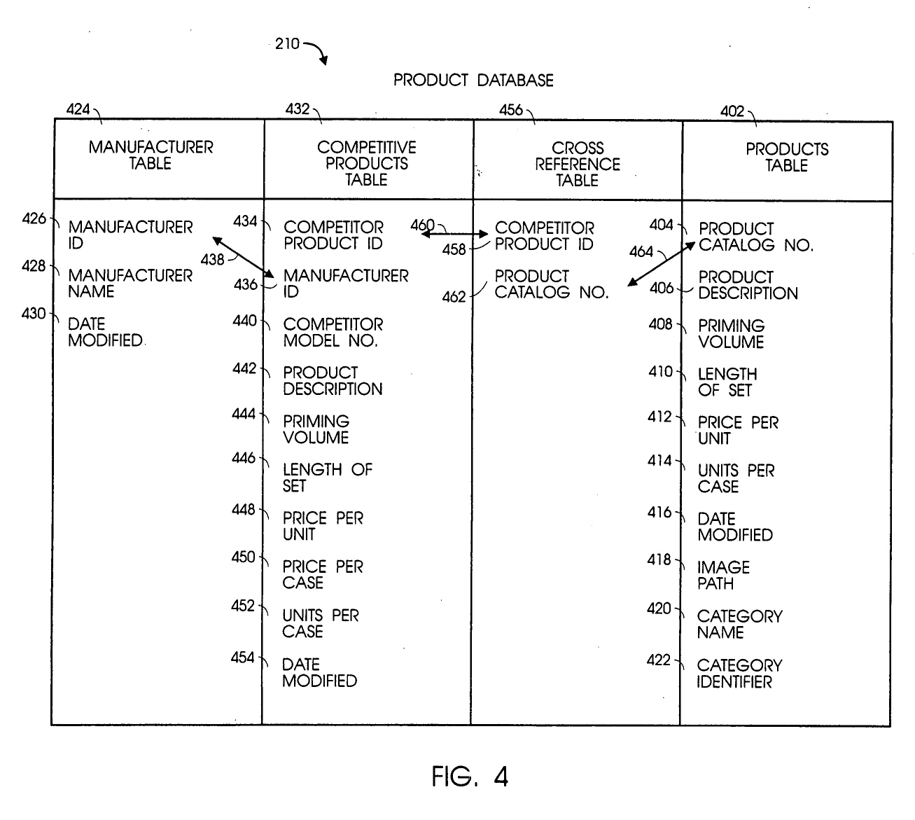

In an embodiment of the present invention wherein the merchant markets administration sets for use in the medical industry, FIG. 4 illustrates a product database 210 having a products table 402 defined to have 10 (ten) fields as follows:

| NAME | TYPE |
|---|---|
| product catalog number | string, 32 characters |
| product description | string, 255 characters |
| priming volume | floating point number |
| length of set | floating point number |
| price per unit | money field |
| units per case | integer |
| date last modified | date |
| image path | string, 255 characters |
| category name | string, 127 characters |
| category ID | integer |

The product catalog number 404 corresponds, in this embodiment, to the merchant's catalog number or model number uniquely identifying each particular product sold. The product catalog number 404 is defined as a primary search key. The product description field 406 corresponds to a brief textual summary of the product, the priming volume field 408 indicates the number of ml's of fluid required to prime the tubing set, and the length field 410 provides, in inches, the overall length of the tubing set. The price per unit 412 indicates the dollar-based cost of one unit, and the units per case 414 describes the quantity of the particular tubing set product sold in one case. The date last modified field 416 records the date on which a particular record was last modified or updated and can be quite useful for tracking and remedying any data-related problems. The image path field 418 indicates the location of a graphic image, if one exists, that depicts the particular tubing set product. The graphic image indicated by the image path field 418 may be included in a web page related to the product to provide additional information about the product to a customer. The category name 420 and category ID 422 fields both describe a particular product category for the tubing set.

When the fields of the product table 402 have been designed, the merchant can begin to populate the table with product data. Those of ordinary skill will appreciate that a data entry application may easily be constructed providing a computer screen-based form corresponding to a record in the products table 402. One such data entry application displays 10 text box areas on the screen, each labeled with the name of the field, each text box permitting a data entry operator to key in data of the type permitted by the field definition. Another technique for populating a database table is to write a data migration application, which, when run on a computer, extracts existing data from an existing data storage system (such as a database), organizes the data into records and fields appropriate for the products table 402, and adds the data as records to the products table 402. Such migrations applications are known in the art.

A next step 304, shown in FIG. 3, is to design and populate fields of a manufacturers table. FIG. 4 illustrates a product database 210 having a manufacturers table 424 defined to have 3 (three) fields as follows:

| NAME | TYPE |
|---|---|
| manufacturer ID | integer |
| manufacturer name | string, 64 characters |
| date last modified | date |

The manufacturers table 424 includes information about competitors. Thus, the manufacturer ID field 426 indicates a number assigned by the merchant to identify each manufacturer and is a primary search key. The manufacturer name field 428 provides the name of each competitor represented in the product database 210. For tracking purposes, the date last modified field 430 provides the date on which a record in the manufacturers table 424 was last modified. As described above in connection with the products table 402, the manufacturers table 424 may be populated with data using either a data entry application or a data migration application.

In another step 306, shown in FIG. 3, a merchant or other person designs and populates a competitive products table. FIG. 4 illustrates a product database 210 including a competitive products table 432 useful in the field of medical tubing sets. Fields of the competitive products table 432 are defined as follows:

| NAME | TYPE |
|---|---|
| competitor product ID | integer |
| manufacturer ID | integer |
| competitor catalog number | string, 64 characters |
| product description | string, unlimited characters |
| priming volume | floating point number |
| length of set | floating point number |
| price per unit | money field |
| price per case | money field |
| units per case | integer |
| date last modified | date |

The competitive product ID field 434 indicates a number assigned to uniquely identify each product that competes with a product of the merchant. The competitive product ID is a primary search key. The manufacturer ID field 436 corresponds to the assigned value identifying the manufacturer of the competing product. The manufacturer ID field 436 may be cross-referenced 438 to the like-named manufacturer ID field 426 of the manufacturers table 424.

The competitor catalog number field 440 indicates the catalog number the competitor uses to identify a competing product and generally appears in invoices or catalogs generated by the competitor. The purposes of the product description 442, priming volume 444, length of set 446, price per unit 448, units per case 452 and date last modified fields 454 are as described in relation to the products table 402. The price per case field 450 indicates the dollar cost charged by a competitor for a case of a particular competing product.

In a last step 308, shown in FIG. 3, a merchant or other person designs and populates a cross reference table. FIG. 4 illustrates a product database 210 including a cross reference table 456 useful to provide product correspondence information between the products of the merchant and the products of competitors in the field of medical tubing sets. The fields of the cross reference table 456 are described as follows:

| NAME | TYPE |
|---|---|
| competitor product ID | integer |
| product catalog number | string, 32 characters |

The competitor product ID field 458 indicates the same information as and is cross referenced 460 to the competitor product ID field 434 of the competitive products table 432. Similarly, the product catalog number 462 indicates the same information as and is cross referenced 464 to the product catalog number field 404 of the products table 402. Thus, the cross reference table 456 permits the merchant to associate each of its products with a most closely matching product of each competitor.

While the database described in relation to FIGS. 3 and 4 may be useful with the present invention in the field of tubing sets, other database configurations may be equally useful in the same or other fields. Those of ordinary skill will appreciate that the invention is not limited by the type or number of fields defined for any of the tables of the product database 210. Moreover, it is expressly contemplated by the inventors hereto that one or more randomly accessible computer files could comprise product database 210.

Generating Pages

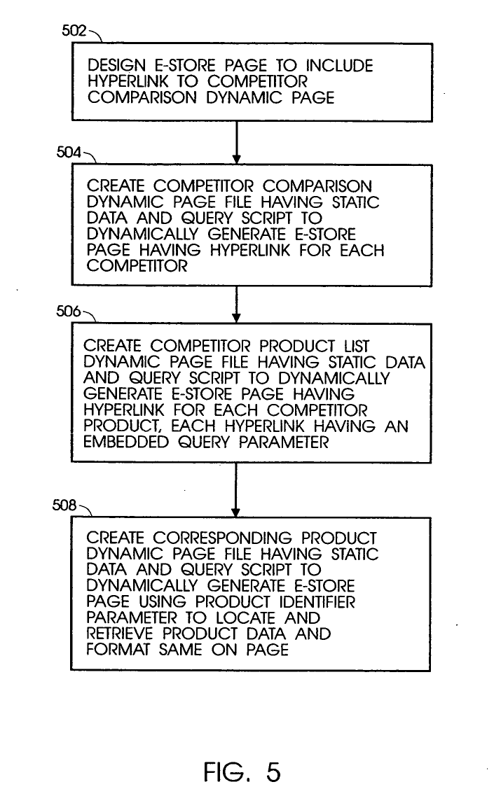

FIG. 5 illustrates steps in one embodiment of the present invention to create e-store pages facilitating customer browsing. In a first step 502, a merchant or other person designs a web page to include a hyperlink to a competitor comparison dynamic page. A number of web page design tools exist, such as Microsoft FrontPage or Microsoft Visual InterDev, any of which can be used to design a web page having hyperlinks.

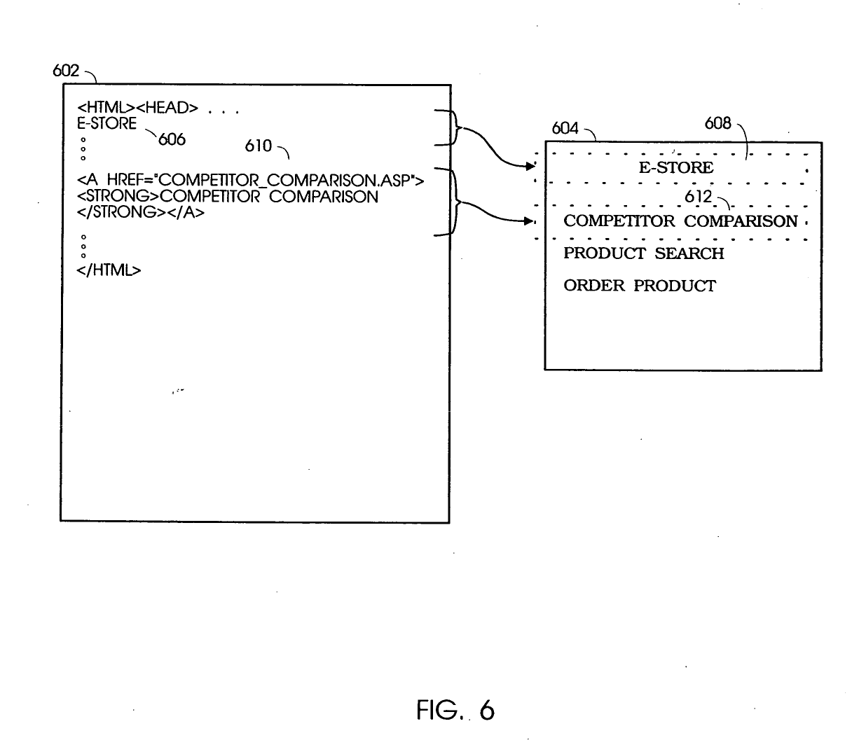

Generally, a web page comprises textual or graphic content “tagged” using HTML tags to identify the nature of the content and which may be interpreted to describe the presentation format of the content. FIG. 6 illustrates a representation, in one embodiment of the present invention, of a page file 602 which may be transmitted by the page server 202 to a customer browser 214. FIG. 6 further illustrates, as an example, a web page 604 received and displayed by the customer browser 214. The page file 602 includes the text content “E-STORE” which is tagged to format that content as a heading 608 on the displayed web page 604.

The page file 602 also includes tagged data 610 which generates a hyperlink 612 on the displayed web page 604. Thus, when a customer viewing the displayed web page 604 clicks on the hyperlink 612, the customer browser 214 sends a request to the page server 202 for a page identified as “competitor_comparison.asp”.

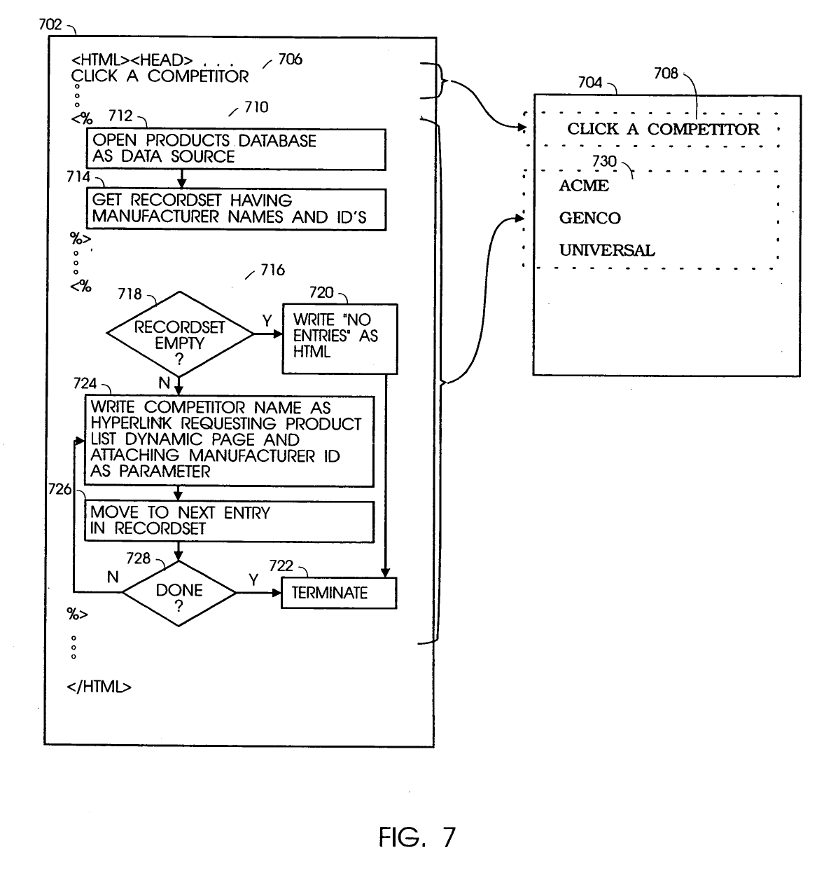

In a next step 504, shown in FIG. 5, a merchant or other person creates a competitor comparison dynamic page file. FIG. 7 illustrates a representation, in one embodiment of the present invention, of a competitor comparison dynamic page file 702, which, when requested by a customer browser 214, generates an HTML web page served by the page server 202. FIG. 7 further illustrates, as an example, a web page 704 received and displayed by the customer browser 214 as a result of the request. In one embodiment, the competitor comparison dynamic page file is an ASP (Active Server Page) file. As will be appreciated by those of ordinary skill in the art, the Visual InterDev tool can be used to create an ASP file.

A dynamic page file, in accordance with the present invention, may be any set of instructions specifying content—directly, indirectly or conditionally—and instructions for formatting that content, the content possibly including hyperlinks for requesting other page files or dynamic page files.

The competitor comparison dynamic page file 702 includes tagged content 706 which a customer browser 214 interprets to generate a heading 708 on the displayed web page 704. The competitor comparison dynamic page file 702 also includes scripts, delimited in the file by opening “<%” and closing “%>” delimiters, which scripts, in this embodiment, locate and format data for the web page 704 each time a customer browser 214 requests the page. An ASP layer of IIS parses and processes commands in the scripts. As those of ordinary skill in the art will appreciate, the scripts may be quite powerful and (1) may contain programming language commands for conditional processing, (2) may open data source connections to external sources of data, (3) may define queries to obtain recordsets from external databases, and (4) may write HTML tagged content to add to a web page before it is served to a requesting browser.

In one embodiment, scripts may contain a subset of the programming language commands comprising Microsoft's Visual Basic programming language. Moreover, script instructions may open connections to sources of data using data source names (DSN's), which may be defined using the Control Panel of Microsoft Windows NT. A DSN may identify a database such as the product database 210 defined herein.

Scripts may define queries using standard query language (SQL), although different query languages may be used. In one embodiment of the present invention, scripts define queries using SQL, and the script processor 204 presents these queries to the database engine 206, which, in this embodiment, is Microsoft Access. The database engine 206 returns a recordset upon processing a query.

A first script 710, in a first step 712, establishes a connection to a data source using a DSN which identifies the product database 210. In a next step 714, the script queries the product database 210 to obtain a recordset including manufacturer names and ID's extracted from records in the manufacturers table 424. One example of such a query is:
SELECT tbIManufacturer.ManufacturerName, tbIManufacturer.ManufacturerID
FROM tblCompProducts, tblManufacturer, tblCrossReference
WHERE tblCompProducts.ManufacturerID=tbIManufacturer.ManufacturerlD
   AND tblCompProducts.CompProdID=tblCrossReference.CompProdID
GROUP BY tbIManufacturer.ManufacturerName, tbIManufacturer.ManufacturerID

A second script 716, in a first step 718, checks the recordset to determine if it is empty. If so, then, in a step 720, the script 716 writes as HTML tagged content “no entries” and, in a step 722, the script terminates. If, in the step 718, the script determines that the recordset is not empty, then, in a next step 724, the script writes the manufacturer name (competitor name) from the present record as an HTML tagged hyperlink. The hyperlink includes a request reference to a competitor product list dynamic page, and also includes a manufacturer ID as a parameter attached to the hyperlink.

In a next step 726, the script moves to the next record in the recordset. If, in a further step 728, the script determines there are no more records in the recordset, then, the script terminates in the step 722. Otherwise the script iterates to the step 724 to process data from the next record.

If the recordset obtained and processed by the scripts 710, 716 includes some records from the manufacturers table 424, then the script will generate hyperlinks 730 in the web page served to and displayed by the customer browser 214.

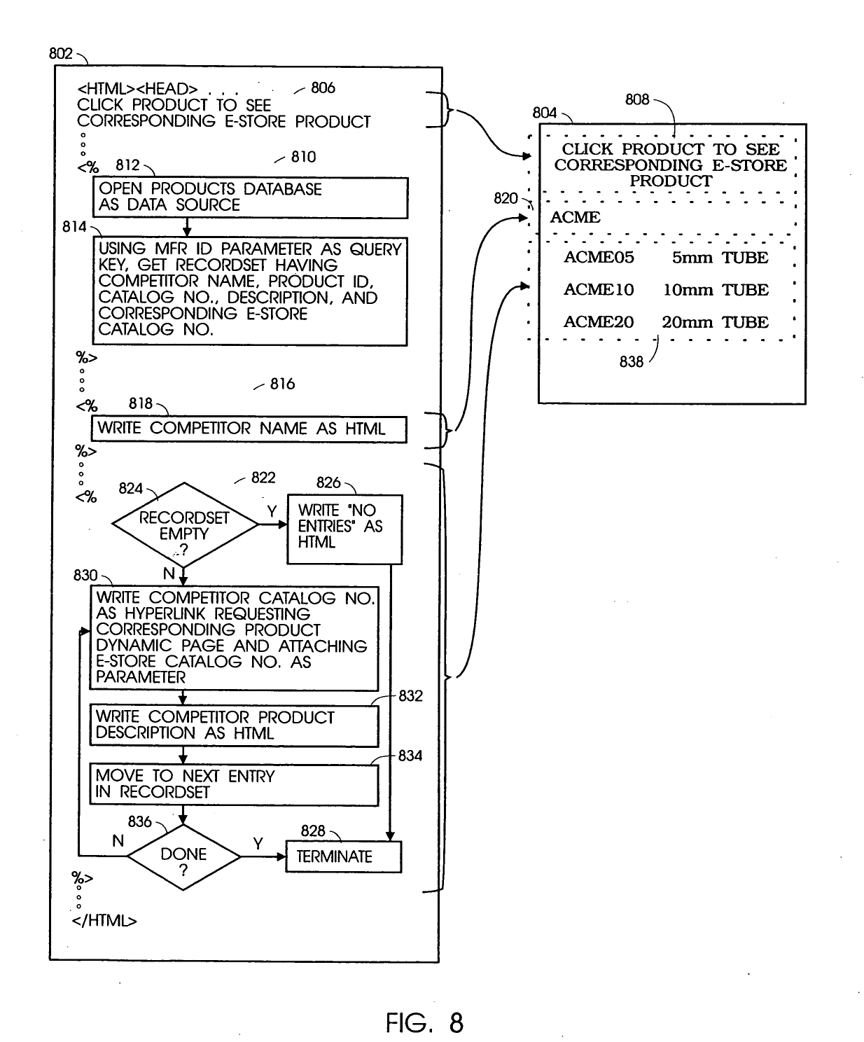

In a further step 506, shown in FIG. 5, a merchant or other person creates a competitor product list dynamic page. FIG. 8 illustrates a representation of a competitor product list dynamic page file 802, which, when requested by a customer browser 214, generates an HTML web page served by the page server 202. FIG. 8 further illustrates, as an example, a web page 804 received and displayed by the customer browser 214 as a result of the request. The dynamic page file 802 is, in one embodiment, an ASP page file, including tagged content 806 which is interpreted by the customer browser 214 as a heading 808 on the displayed web page 804.

The dynamic page file 802 also includes scripts. A first script 810, in a first step 812, uses a DSN to open a connection with the product database 210. In a next step 814, the script 810 uses the manufacturer ID supplied by the customer browser in connection with its request for the page file 802, to query the product database 210 and return a recordset. The recordset includes the manufacturer (competitor) name associated with the manufacturer ID parameter, and the competitor product ID, competitor catalog number and description for every competing product in the database having the manufacturer ID supplied by the customer browser. The script also accesses the cross reference table 456 to include in the recordset the merchant e-store product catalog number corresponding to each competitor product represented in the recordset. The following is one example of such a query:
SELECT tblCrossReference.CatalogNumber, tblCompProducts.PrimingVolume, tblCompProducts.Description, tblCompProducts.Length, tblCompProducts.CatalogNumber, tblCompProducts.ManufacturerID, tblCompProducts.CompProdID, tbIManufacturer.ManufacturerName, tblCompProducts.NumberPerCase
FROM tblCrossReference, tblCompProducts, tbIManufacturer
WHERE tblCrossReference.CompProdID=tblCompProducts.CompProdID
AND tblCompProducts.ManufacturerID=tbIManufacturer.ManufacturerID
AND (tblCompProducts.ManufacturerID=“& intID &”)
ORDER BY tblCompProducts.CatalogNumber
(NOTE: intID holds the value of the Manufacturer ID parameter)

A second script 816, in a step 818, writes the manufacturer name as HTML tagged content. The customer browser 214 interprets that tagged content to display it as a subheading 820 on the displayed web page 804.

A third script 822 in the dynamic page file 802, in a step 824, checks the recordset to determine if it is empty. If so, then, in a step 826, the script 822 writes as HTML tagged content “no entries” and, in a step 828, the script terminates. If, in the step 824, the script determines that the recordset is not empty, then, in a next step 830, the script writes the competitor catalog number from the present record as an HTML tagged hyperlink associated with a competing product. The hyperlink includes a request reference to a corresponding product dynamic page, and also includes the e-store product catalog number corresponding to the competitor catalog number as a parameter attached to the hyperlink.

In a further step 832, the script 822 writes the competitor product description as HTML tagged content to be displayed on the web page 804 accompanying the hyperlink associated with that competing product. In a next step 834, the script 822 moves to the next record in the recordset. If, in a further step 836, the script determines there are no more records in the recordset, then, the script terminates in the step 828. Otherwise the script iterates to the step 830 to process data from the next record.

If the recordset obtained in the script 810 includes records, then, when a customer browser 214 requests the dynamic page file 802, the page server 202 will serve an HTML web page 804 including hyperlinks 838 associated with competing products of a single competitor.

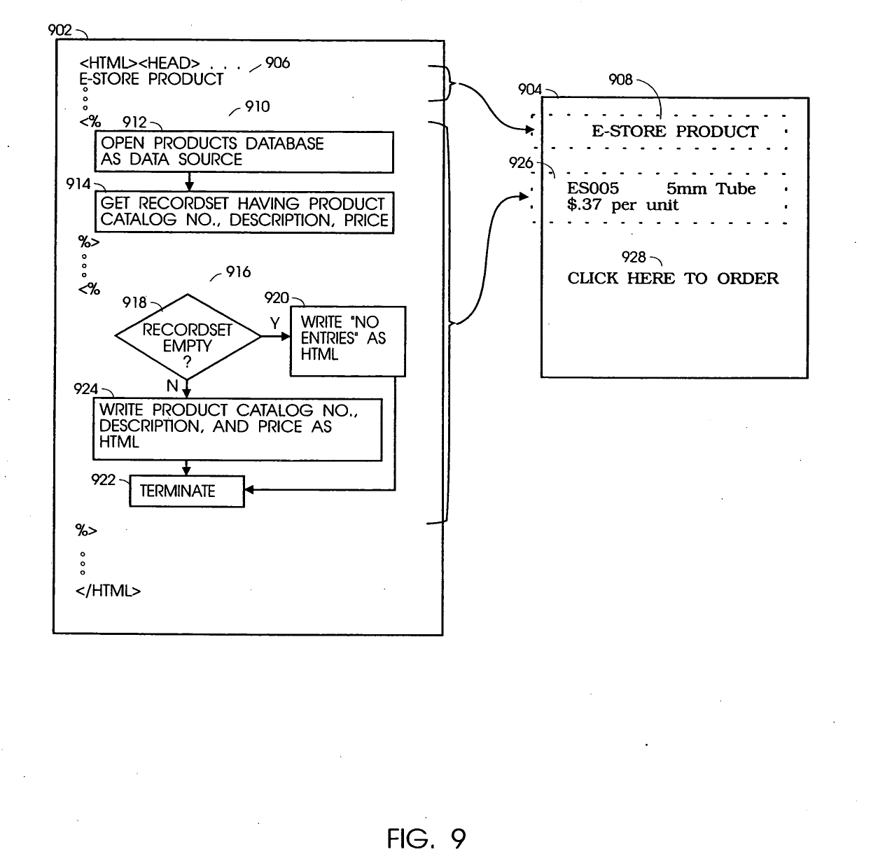

In a further step 508, shown in FIG. 5, the merchant or other person creates a corresponding product dynamic page. FIG. 9 illustrates a representation of a corresponding product dynamic page file 902, which, when requested by a customer browser 214, causes a web page to be generated and served to the customer browser 214. FIG. 9 illustrates, as one example, such a web page 904 received and displayed by the customer browser 214.

The corresponding product dynamic page file 902 includes tagged content 906 which, when received and displayed by the customer browser 214, is formatted as a heading 908 on the web page 904.

The dynamic page file 902 includes a first script 910. The script 910, in a first step 912, opens a connection to the product database 210. In a next step 914, the script 910 uses the e-store product catalog number passed as a parameter from the customer browser 214, to query the product database 210 and to obtain a recordset including the e-store product catalog number, and the associated product description and price per unit. The recordset typically includes a single record.

The dynamic page file 902 includes a second script 916 which, in a first step 918, checks the recordset to determine if it is empty. If so, then, in a step 920, the script 916 writes as HTML tagged content “no entries” and, in a step 922, the script terminates. If, in the step 918, the script determines that the recordset is not empty, then, in a next step 924, the script 916 writes the e-store product catalog number, description and price information as HTML tagged content. The script 916 terminates in the step 922.

If the recordset obtained by the script 910 includes a record, then the page server 202 serves a web page which the customer browser 214 will interpret to display information 926 about an e-store product. Optionally, the dynamic page file 902 could include a hyperlink 928 having the e-store product catalog number as a parameter which requests a web page that permits a customer to order some number of units of the e-store product.

Operation of Browsing System

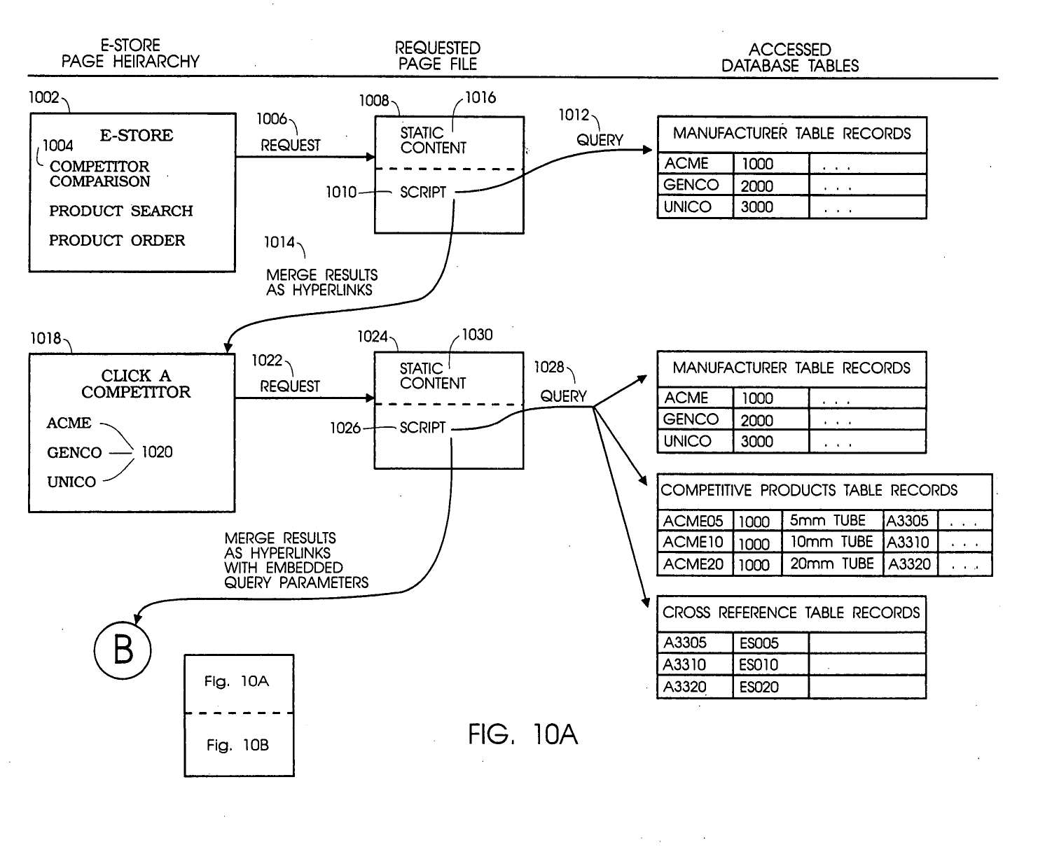

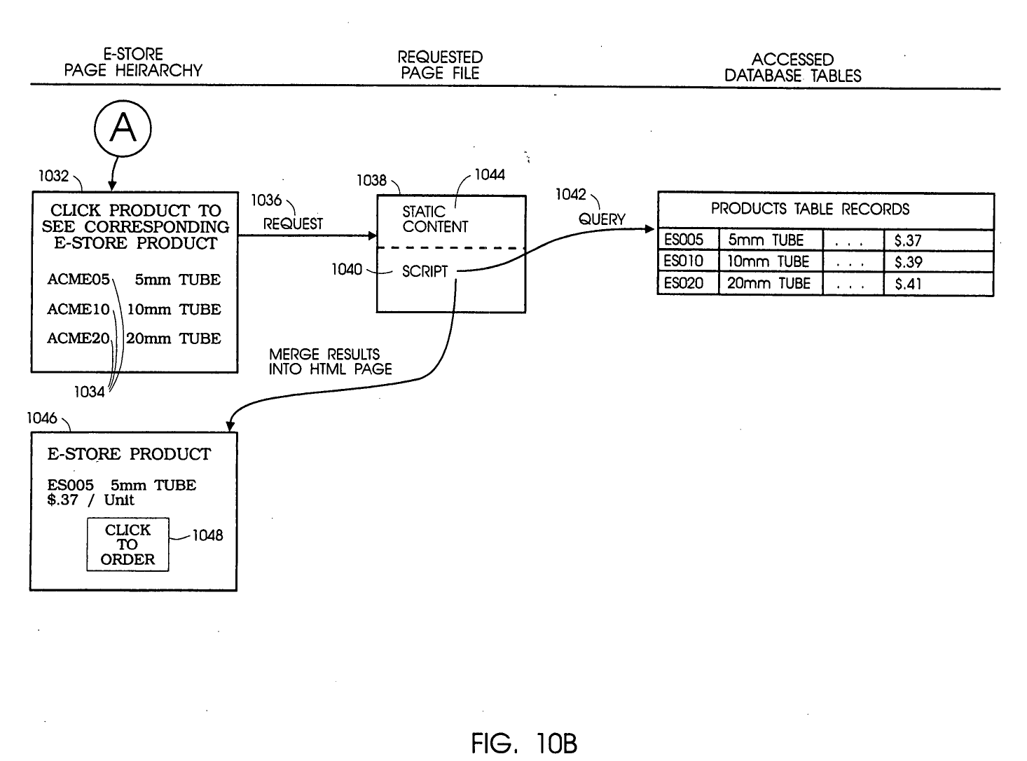

FIGS. 10A and 10B comprise a flow diagram representing the operation of an embodiment of the present invention compatible with an Internet-based electronic store. A customer using a customer browser 214 accesses and displays a high-level web page 1002 of an electronic store (e-store) having a competitor comparison hyperlink 1004.

When the customer clicks the competitor comparison hyperlink 1004, the customer browser 214 issues a request 1006 for a competitor comparison dynamic page file 1008. The page server 202 accesses that dynamic page file 1008, and a script processor 204 parses and processes script components 1010 of the dynamic page file 1008. In particular, according to instructions of the script components 1010, the script processor 204 open a connection to the product database 210 and issues a query to the manufacturers table 424 and obtains a recordset including records having manufacturer name (e.g., “ACME”) and manufacturer ID (e.g., “1000”) information.

The script processor 204 processes additional commands to iterate through the recordset, writing, for each manufacturer, a hyperlink requesting a competitor product list dynamic page, each hyperlink having a particular manufacturer ID as a parameter. Those hyperlinks are merged 1012 with static tagged content 1014 to generate HTML compliant data for a web page. The page server 202 transmits the web page to the customer browser 214 which receives and displays the web page 1018.

The web page 1018 offers the customer hyperlinks 1020 relating to competitors. If the customer happens to be familiar with one of the competitors, the customer may click a hyperlink relating to that competitor. When the customer clicks any of the hyperlinks 1020 (e.g., the hyperlink for the “ACME” competitor), the customer browser 214 transmits to the page server 202 a request 1022 for a competitor product list dynamic page file 1024. The customer browser 214 transmits along with the request the manufacturer ID associated with the selected manufacturer.

The page server 202 accesses the competitor product list dynamic page file 1024, and the script processor 204 processes instructions in script components 1026 of the dynamic page file 1024. The instructions open a connection to the product database 210 as a data source, and use the manufacturer ID (e.g., “1000”) to issue a query 1028 to the manufacturers table 424, the competitive products table 432, and the cross reference table 456. The results of the query form a recordset including information about all the products of the selected competitor that are represented in the product database 210, as well as the catalog numbers of corresponding products of the merchant. The script processor 204, processing instructions of the script components 1026, uses the recordset information to construct an HTML-tagged hyperlink for each product of the selected competitor, attaching as a parameter to each hyperlink, the catalog number of the merchant's corresponding product.

Additional script instructions are processed to merge the hyperlinks with static tagged content 1030 to generate data for a competitor product list web page. The page server 202 transmits the web page data to the customer browser 214, and the customer browser 214 displays the competitor product list web page 1032 (see FIG. 10B).

The competitor product list web page 1032 offers the customer hyperlinks 1034 corresponding to products of the selected competitor. When the customer clicks any of the competitor product hyperlinks 1034 (e.g., “ACME05”), the customer browser 214 issues a request 1036 for a corresponding product dynamic page file 1038. The customer browser 214 transmits with the request, the catalog number of the particular merchant's product that corresponds to the selected competitor product.

The page server 202, receives the request, accesses the corresponding product dynamic page file 1038, and the script processor 204 processes script components 1040 of that dynamic page file 1038. In processing the instructions, the script processor 204 opens a connection to the product database 210, and uses the merchant catalog number to issue a query 1042 to the products table 402 for information about the merchant's corresponding product (e.g., product description and price per unit). Generally, the query results in the return of a single record. Instructions in the script components 1040 cause the resulting data to be tagged as HTML content and merged with static content 1044 to generate corresponding product web page data

The page server 202 transmits the corresponding product web page data to the customer browser 214 which receives the data and displays it as a corresponding product web page 1046. Thus, the customer uses information about a competitor's product to browse and locate information about a corresponding product of the merchant.

The invention may be adapted to include a product order hyperlink 1048 on the corresponding product web page 1046. In that adaptation, the script components 1040 include instructions which generate a “CLICK TO ORDER”-labeled hyperlink, and attach to the hyperlink the merchant's corresponding product catalog number. The product order hyperlink is constructed to request a product order page file. The page server 202 receives the request and transmits a product order web page to the customer browser 214. The product order web page elicits from the customer order data such as number of units, shipping method and address, and payment method. Such product order web pages are well known in the art.

In another adaptation of the present invention, the competitor product list web page 1032 includes a form below each product hyperlink 1034. Each instance of the form includes a first text entry field labeled “enter your current price each:”, a second text entry field labeled “monthly usage in cases:”, and a savings hyperlink labeled “CALCULATE MY SAVINGS.” The form is designed to assign to a price parameter the value entered by the customer in the first field, and to assign to a quantity parameter the value entered by the customer in the second field. The savings hyperlink has as an attached parameter the merchant's catalog number for the product corresponding to the competitor product described immediately above the form. Additionally, the savings hyperlink has a savingsID parameter to which is assigned the value TRUE.

When the user enters information in the price field (e.g., “0.42”) and in the quantity field (e.g., “5”) and then clicks the savings hyperlink, the customer browser 214 issues a request for the corresponding product dynamic page file 1038. In this adaptation, conditional processing instructions in the script components 1040 detect that the savingsID parameter equals “TRUE” and, in that case, a set of instructions associated with the savings hyperlink are processed to handle the request differently from the request 1036 described in connection with FIG. 10B.

When the customer uses the savings hyperlink to request the corresponding product dynamic page file 1038, the script processor 204 issues a query to the products table 402 to retrieve a value from the price per unit field of the corresponding product. The script processor 204 also issues a query to the competitive products table 432 to retrieve a value from the units per case field for the competing product.

Next the script processor 204 calculates a comparison quantity of the competing product by multiplying the quantity parameter (number of cases) by the units per case value. Then the script processor 204 calculates a competing product cost by multiplying the price parameter by the comparison quantity. The script processor also calculates a corresponding product cost by multiplying the comparison quantity by the price per unit value of the corresponding product. As a final calculation, the script processor 204 subtracts the corresponding product cost from the competing product cost to derive a savings value.

If the savings value is a positive number, then the script processor 204 tags the savings value as HTML content, and the page server 202 transmits a savings web page to the customer browser displaying the savings value in formatted text. If the savings value is negative or zero, then the script processor 204 includes in the savings web page an HTML tagged message indicating how quickly the merchant can ship its products, despite the lack of savings. The page server 202 then transmits the savings web page to the customer browser.

This invention may be embodied in other specific forms without departing from the essential characteristics as described herein. The embodiments described above are to be considered in all respects as illustrative only and not restrictive in any manner. The scope of the invention is indicated by the following claims rather than by the foregoing description. Any and all changes which come within the meaning and range of equivalency of the claims are to be considered within their scope.

What is claimed is:

1. A method for locating product information, comprising the steps of:
displaying first competitor product information indicative of a first competitor product, the first competitor product having performance features at least some of which are interchangeable with performance features of a first product;
while displaying the first competitor product information, also displaying second competitor product information indicative of a second competitor product, the second competitor product having performance features at least some of which are interchangeable with performance features of a second product, the second competitor product and the first competitor product both of the same competitor, and the second product and the first product both of the same merchant; and
selecting an option associated with the display of the first competitor product information to retrieve and display information indicative of the first product.
